(19) United States
(12) Patent Application Publication
(10) Pub. No.: US 2017/0091918 A1
(43) Pub. Date: Mar. 30, 2017

(54) PRINTED CIRCUIT BOARD CHECKING SYSTEM

(71) Applicants: KANG ZHUN ELECTRONICAL TECHNOLOGY (KUNSHAN) CO., LTD., Kunshan (CN); HON HAI PRECISION INDUSTRY CO., LTD., New Taipei (TW)

(72) Inventors: XU-HONG LI, Kunshan (CN); HUA CHANG, Kunshan (CN)

(21) Appl. No.: 14/880,736

(22) Filed: Oct. 12, 2015

(30) Foreign Application Priority Data
Sep. 25, 2015 (CN) 201510619320.X

(51) Int. Cl. G06T 7/00; H04N 5/225; H04N 5/232

(52) U.S. Cl. CPC G06T 7/001; H04N 5/232; H04N 5/2256; G06T 2207/10004; G06T 2207/30141

(57) ABSTRACT

A printed circuit board checking system includes a movement mechanism, an image capturing unit, an image analyzing unit, a storage unit and a determining unit. The image capturing unit moves in response to motion of the movement mechanism, relative to a printed circuit board moves in X axis, Y axis and Z axis and continuously captures a number of images of the printed circuit board. The image analyzing unit analyzes the number of images to obtain an arrangement information of elements of the printed circuit board. The storage unit stores a standard arrangement information of elements of the printed circuit board. The determining unit determines which element does not meet requirement according to the analyzed arrangement information of the element of the printed circuit board and the standard arrangement information of the element of the printed circuit board.

### CROSS-REFERENCE TO RELATED APPLICATIONS

This application claims priority to Chinese Patent Application No. 201510619320.X, filed on Sep. 25, 2015, the contents of which are incorporated by reference herein.

### FIELD

The subject matter herein relates to a printed circuit board checking system.

### BACKGROUND

Printed circuit boards are necessary to electronic devices. The printed circuit board must be checked to determine whether it meets requirements. The printed board is checked by people.

### BRIEF DESCRIPTION OF THE DRAWINGS

Implementations of the present technology will now be described, by way of example only, with reference to the attached figures.

FIG. 1 is an isometric view of a printed circuit board checking system.

FIG. 2 is an interior isometric view of the printed circuit board checking system of FIG. 1.

FIG. 3 is a partly exploded isometric view of the printed circuit board checking system of FIG. 2.

FIG. 4 is a block diagram of the printed circuit board checking system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series, and the like.

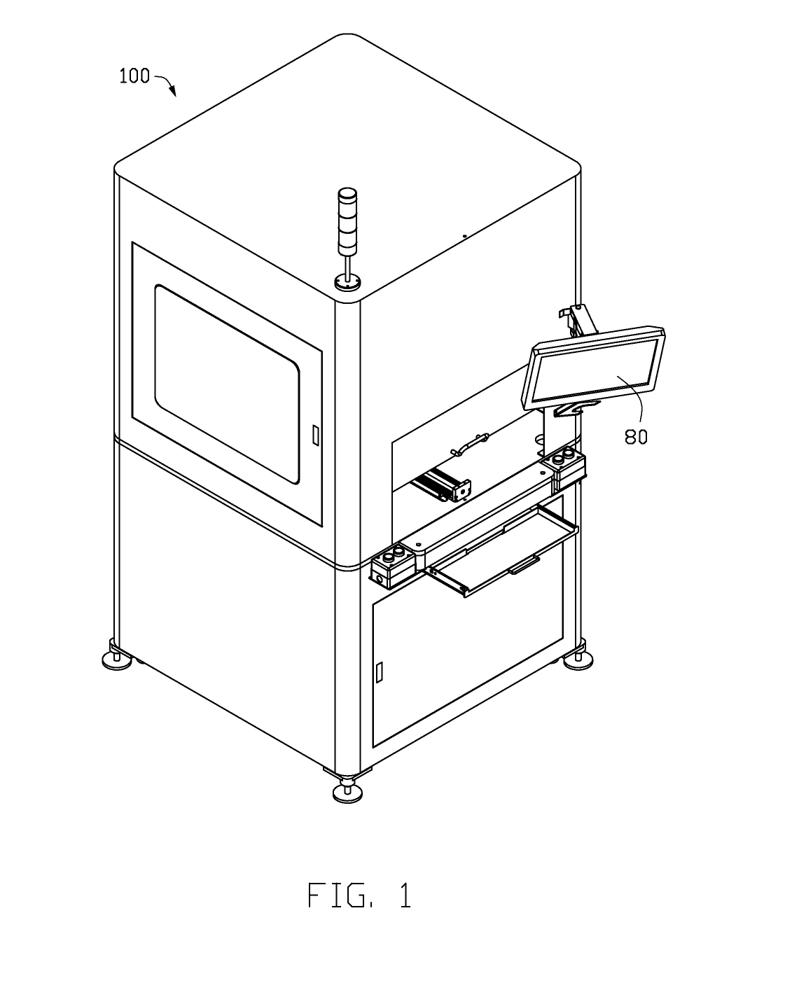

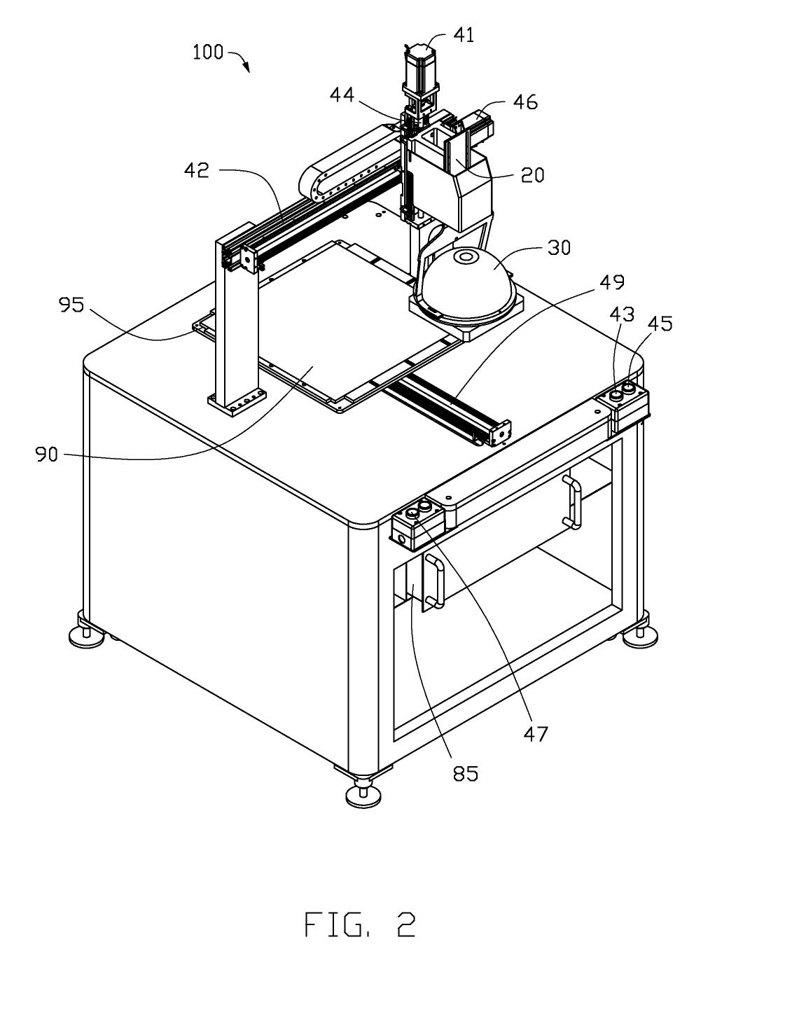

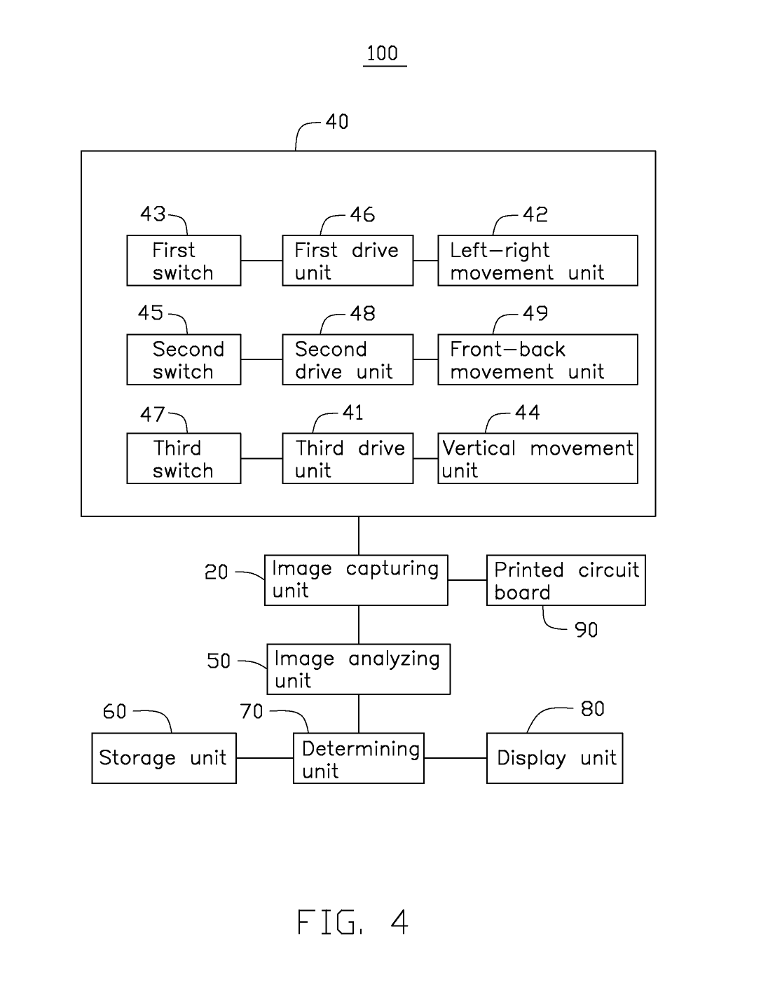

FIG. 1 illustrates a printed circuit board checking system 100. The printed circuit board checking system 100 includes an display unit 80. FIG. 2 illustrates that the printed circuit board checking system 100 further includes an image capturing unit 20, a host 85 and a light source 30. FIG. 4 illustrates that the printed circuit board checking system 100 further includes a movement mechanism 40, an image analyzing unit 50, a storage unit 60, a determining unit 70. The image analyzing unit 50, the storage unit 60 and the determining unit 70 are set in the host 85. The printed circuit board checking system 100 is configured to check whether an arrangement of elements of a printed circuit board 90 meets requirements. The elements of the printed circuit board 90 include pins, sockets, inductance and so on.

The image capture unit 20 and the light source 30 are attached to the movement mechanism 40 and positioned above the printed circuit board 90. The light source 30 lightens the printed circuit board 90. When the movement mechanism 40 moves, the image capture unit 20 relative to the printed circuit board 90 moves in X axis, Y axis and Z axis and continuously captures a number of images. The image capture unit 20 is charge couple device camera. The captured images includes elements of the printed circuit board 90 to be checked. In an embodiment, the captured images includes all elements of the printed circuit board 90. The image analyzing unit 50 analyzes the captured images to obtain an arrangement information of each element of the printed circuit board 90 to be checked. The storage unit 60 stores a standard arrangement information of each element of the printed circuit board 90 to be checked. The standard arrangement information includes a standard arrangement parameter and a standard arrangement image. The determining unit 70 determines whether the arrangement of elements of the printed circuit board 90 meets requirements and which element does not meet requirement according to the analyzed arrangement information of each element of the printed circuit board 90 to be checked and the standard arrangement information of each element of the printed circuit board 90 to be checked. The display unit 80 displays a checked result of the printed circuit board 90.

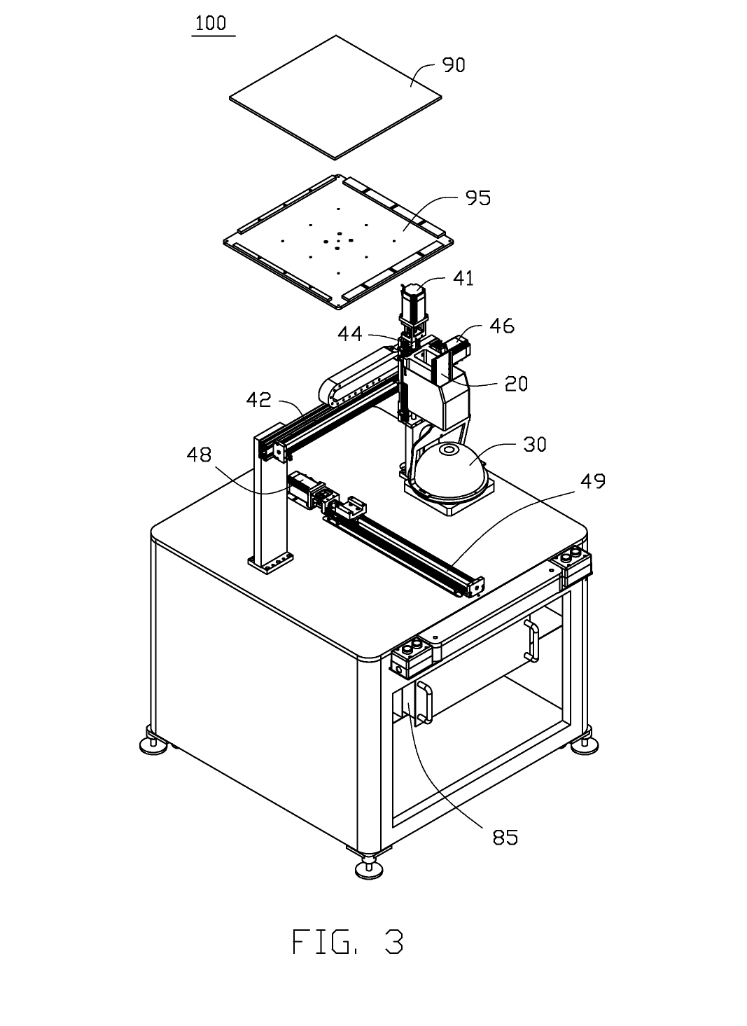

The movement mechanism 40 includes a left-right movement unit 42, a front-back movement unit 49, a vertical movement unit 44, a first drive unit 46, a second drive unit 48 and a third drive unit 41. Referring to FIG. 3, the left-right movement unit 42 is positioned above a tray 95 and parallel to the tray 95. The printed circuit board 90 is received in the tray 95. The tray 95 is positioned on the front-back second movement unit 49. The vertical movement unit 44 is attached to the left-right movement unit 42 and perpendicular to the printed circuit board 90. The light source 30 and the image capture unit 20 are attached to the vertical movement unit 44. The third drive unit 41 drives the vertical movement unit 44 to move in Z axis to adjust a distance between the image capturing unit 20 and the printed circuit board 90. The first drive unit 46 drives the left-right movement unit 42 to move in X axis. The second drive unit 48 drives the front-back movement unit 49 to move in Y axis. The first drive unit 46, the second drive unit 48 and the third drive unit 41 are stepper motors. The left-right movement unit 42, the front-back movement unit 49 and the vertical movement unit 44 include a screw. The stepper motor drives the screw to rotate to drive the printed circuit board 90, the image capture unit 20 and the light source 30 to move.

The movement mechanism 40 further includes a first switch 43, a second switch 45 and a third switch 47. The first switch 43 controls the left-right movement unit 42 to work in response to an operation to it. The second switch 45 controls the front-back movement unit 49 to work in response to an operation to it. The third switch 47 controls the vertical movement unit 41 to work in response to an operation to it.

The embodiments shown and described above are only examples. Even though numerous characteristics and advantages of the present technology have been set forth in the foregoing description, together with details of the structure and function of the present disclosure, the disclosure is illustrative only, and changes may be made in the details, including in matters of shape, size and arrangement of the parts within the principles of the present disclosure up to, and including, the full extent established by the broad general meaning of the terms used in the claims.

What is claimed is:

1. A printed circuit board checking system comprising:
a movement mechanism being movable in X axis, Y axis and Z axis;
an image capturing unit attached to the movement mechanism and configured to move in response to motion of the movement mechanism, relative to a printed circuit board moves in X axis, Y axis and Z axis and continuously captures a plurality of images;
an image analyzing unit configured to analyze the plurality of images to obtain an arrangement information of each element of the printed circuit board to be checked;
a storage unit coupled to the image analyzing unit and configured to have a standard arrangement information of each element of the printed circuit board to be checked stored thereon; and
a determining unit configured to determine whether the arrangement of elements of the printed circuit board meets requirements according to the analyzed arrangement information of each element of the printed circuit board and the standard arrangement information of each element of the printed circuit board.

2. The printed circuit board checking system as claimed in claim 1, wherein the captured images comprises all elements of the printed circuit board.

3. The printed circuit board checking system as claimed in claim 1, wherein the image capture unit is charge couple device camera.

4. The printed circuit board checking system as claimed in claim 1, further comprising:
a light source configured to lighten the printed circuit board.

5. The printed circuit board checking system as claimed in claim 1, wherein the standard arrangement information comprises a standard arrangement parameter and a standard arrangement image.

6. The printed circuit board checking system as claimed in claim 1, further comprising:
a display unit configured to display a checked result of the printed circuit board.

7. The printed circuit board checking system as claimed in claim 1, wherein the movement mechanism comprises a left-right movement unit, a front-back movement unit, a vertical movement unit, the printed board is positioned on the front-back movement unit, the vertical movement unit is attached to the left-right movement unit, the image capture unit is attached to the vertical movement unit, the left-right movement unit is movable in X axis, the front-back movement unit is movable in Y axis, the vertical movement unit is movable in Z axis.

8. The printed circuit board checking system as claimed in claim 7, wherein the movement mechanism further comprises first drive unit, a second drive unit and a third drive unit, the first drive unit drives the left-right movement unit to move, the second drive unit drives the front-back movement unit to move, the third drive unit drives the vertical movement unit to move.

9. The printed circuit board checking system as claimed in claim 8, wherein the first drive unit, the second drive unit and the third drive unit are stepper motors, the left-right movement unit, the front-back movement unit and the vertical movement unit comprises a screw, the stepper motor drives the screw to rotate to drive the printed circuit board and the image capture unit to move.

10. The printed circuit board checking system as claimed in claim 8, wherein movement mechanism further comprises a first switch, the first switch controls the left-right movement unit to work in response to an operation to first switch.

11. A printed circuit board checking system comprising:
a movement mechanism being movable in X axis, Y axis and Z axis;
an image capturing unit attached to the movement mechanism and configured to move in response to motion of the movement mechanism, relative to a printed circuit board moves in X axis, Y axis and Z axis and continuously captures a plurality of images of the printed circuit board;
an image analyzing unit configured to analyze the plurality of images to obtain an arrangement information of elements of the printed circuit board to be checked;
a storage unit coupled to the image analyzing unit and configured to have a standard arrangement information of each element of the printed circuit board to be checked stored thereon; and
a determining unit configured to determines which element does not meet requirement according to the analyzed arrangement information of the element of the printed circuit board and the standard arrangement information of the element of the printed circuit board.

12. The printed circuit board checking system as claimed in claim 11, wherein the captured images comprises all elements of the printed circuit board.

13. The printed circuit board checking system as claimed in claim 11, wherein the image capture unit is charge couple device camera.

14. The printed circuit board checking system as claimed in claim 11, further comprising:
a light source configured to lighten the printed circuit board.

15. The printed circuit board checking system as claimed in claim 11, wherein the standard arrangement information comprises a standard arrangement parameter and a standard arrangement image.

16. The printed circuit board checking system as claimed in claim 11, further comprising:
a display unit configured to displays a checked result of the printed circuit board.

17. The printed circuit board checking system as claimed in claim 11, wherein the movement mechanism comprises a left-right movement unit, a front-back movement unit, a vertical movement unit, the printed board is positioned on the front-back movement unit, the vertical movement unit is attached to the left-right movement unit, the image capture unit is attached to the vertical movement unit, the left-right movement unit is movable in X axis, the front-back movement unit is movable in Y axis, the vertical movement unit is movable in Z axis.

18. The printed circuit board checking system as claimed in claim 17, wherein the movement mechanism further comprises first drive unit, a second drive unit and a third drive unit, the first drive unit drives the left-right movement unit to move, the second drive unit drives the front-back movement unit to move, the third drive unit drives the vertical movement unit to move.

19. The printed circuit board checking system as claimed in claim 18, wherein the first drive unit, the second drive unit and the third drive unit are stepper motors, the left-right movement unit, the front-back movement unit and the vertical movement unit comprises a screw, the stepper motor drives the screw to rotate to drive the printed circuit board and the image capture unit to move.

20. The printed circuit board checking system as claimed in claim 18, wherein movement mechanism further comprises a first switch, the first switch controls the left-right movement unit to work in response to an operation to first switch.
